(19) United States
(12) Patent Application Publication
(10) Pub. No.: US 2006/0066191 A1
(43) Pub. Date: Mar. 30, 2006

(54) Dielectric barrier discharge lamp having an electric shield

(75) Inventors: Georg Bschorer, Herbrechtingen (DE); Reinhard Lecheler, Neuburg/Donau (DE); Andreas Lochschmidt, Jettingen-Scheppach (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/226,414

(22) Filed: Sep. 15, 2005

(30) Foreign Application Priority Data
Sep. 29, 2004 (DE) 10 2004 047 374.9

(51) Int. Cl. H01J 5/16; H01K 1/26; H01K 1/30

(52) U.S. Cl. 313/110; 313/111; 313/113

(57) ABSTRACT

The invention relates to a dielectric barrier discharge lamp having an EMC shield which has shielding faces which protrude outwards from the discharge vessel and limit a light exit angle of opening.

### TECHNICAL FIELD

The present invention relates to a dielectric barrier discharge lamp. Dielectric barrier discharge lamps are understood to mean discharge lamps in which at least the anodes or, in the case of bipolar operation, even all of the electrodes, are isolated from a discharge medium in the discharge vessel by a dielectric layer. This results in automatic quenching of the discharge by internal counterpolarization as a result of the dielectric layer on the anode or the electrode, which in this phase acts as the anode, being electrically charged. Lamp operation therefore takes place finally by means of a dense row of very short discharge flashes.

### BACKGROUND ART

Such dielectric barrier discharge lamps have been disclosed in different ways in the prior art and are of interest, owing to various advantageous technical properties, in particular for backlighting displays, for example computer monitors and television screens, or for office automation applications. In the lastmentioned case, lamp shapes which are in the form of elongate rods are generally used which can be used to illuminate documents in scanners, fax machines, copiers or the like. Those discharge lamps having a discharge vessel which is elongate in the form of a tube are likewise already known and accessible. They may also be of interest for other applications, for example as UV radiators for specific technical processes. The present invention is not restricted to a specific application.

Dielectric barrier discharge lamps cannot be operated using a direct current owing to the discharge mechanism which has been outlined in brief, but are operated either using unipolar power supply pulses or using bipolar power supply pulses. The frequencies used are generally of the order of magnitude of a few 10 kHz, with the result that such discharge lamps produce interference radiation in EMC-sensitive conditions.

It is therefore already known to use metallic shields in dielectric barrier discharge lamps having discharge vessels which are elongate in the form of a tube. Reference may be made by way of example to U.S. Pat. No. 6,304,028 B1, which will also be referred to further below.

The metallic shields need to partially surround the discharge vessel and, on the other hand, leave a certain region free for light radiation purposes. Since the light radiation geometry generally remains substantially the same along the longitudinal extent, this is referred to as an angle of opening. This angle of opening therefore lands on a sectional plane perpendicular to the direction of longitudinal extent.

### DISCLOSURE OF THE INVENTION

The invention is based on a technical problem of specifying a dielectric barrier discharge lamp having a discharge vessel which is elongate in the form of a tube and a conductive metallic shield of the discharge vessel which has been developed in an advantageous manner as regards EMC. The invention is also intended to specify a corresponding illumination system having such a discharge lamp and an associated electronic ballast.

This technical problem is solved by a discharge lamp comprising
a discharge vessel which is elongate in the form of a tube a conductive metallic shield which partially surrounds the discharge vessel and in the process leaves an angle of opening free for light radiation purposes,
   wherein at least one shielding face, limiting the angle of opening, of the shield being remote from the discharge vessel at its outermost end by a distance which is at least as great as half the average diameter of the discharge vessel transverse to the longitudinal extent.

In addition, the invention also relates to an illumination system having such a discharge lamp and an electronic ballast for the purpose of operating the lamp to which the discharge lamp is electrically connected, the electrical connection between the ballast and the discharge lamp being shielded.

Advantageous refinements of the invention are specified in the dependent claims and are explained in more detail in the text which follows. As a precaution, reference is made to the fact that the features disclosed therein can be understood implicitly also as a disclosure of a method for mounting a discharge lamp and an illumination system and as an operating method for the discharge lamp and the illumination system.

Tubular discharge lamps of this type have a so-called aperture along their longitudinal extent, i.e. a longitudinally extending strip, from which light emerges from the lamp. In order to ensure good efficiency, this aperture should if possible not be covered directly by a shield, for which purpose known shields also leave the aperture completely free. However, the lamp then radiates over the entire region which is left free at the corresponding spatial angles. The shielding face provided by the invention delimits the spatial angle of this radiation and thus also defines an angle of opening of the light radiation. This angle of opening can be optimized in terms of the technically desired application, i.e. in an individual case the angle of opening may also be markedly smaller than is actually possible in the case of the aperture provided. In this case, however, the shielding face would not impair the luminous efficiency at the spatial angle relevant to the application, but would markedly improve shielding.

The basic idea of the invention thus consists in the shield not being limited to a conductive envelope, known per se, of the discharge vessel outside the angle of opening but the shield having at least one shielding face which extends away from the discharge vessel and in the process limits the angle of opening. The shield should therefore to a certain extent have a “screen” along at least one lateral boundary of the angle of opening. Corresponding shielding faces are preferably provided at both boundaries of the angle of opening, but a shielding face could also be dispensed with, for example, if the shield in the other direction is not important or is already provided for other reasons, for example by a metallic wall which is provided there in any case. The shielding face in this case does not necessarily need to run along its entire extent along the boundary of the angle of opening, i.e. does not necessarily need to extend substantially radially. At least its outermost end preferably limits the angle of opening. This outermost end is moreover remote from the discharge vessel in accordance with the invention at least by half the average diameter of the discharge vessel.

Moreover, it is also not absolutely necessary for the shield to surround the entire rest of the circumference of the discharge vessel apart from the angle of opening. Here too, owing to the lack of significance of the electromagnetic interference radiation in a specific direction or shielding elements which are provided there in any case, the reasons for a shield may be absent and/or there may be other physical reasons which allow a gap in the shield to appear advantageous.

However, it is preferable in the context of this invention for the shield to surround and shield the discharge vessel and therefore to a certain extent to form a sleeve over more than half of the circumference of said discharge vessel. As is described in more detail below, this sleeve may also have advantageous properties as a mounting aid or holder.

The mentioned sleeve preferably has, over part of the circumference of the discharge vessel, particularly preferably over the remaining part, apart from the shielding face(s), a relatively small distance from the discharge vessel, to be precise in comparison with half the average diameter of the discharge vessel. The remaining part of the shield then forms the mentioned shielding face. For illustrative purposes, reference is made to the exemplary embodiments.

Although the shielding face according to the invention of the shield can limit the light radiation of the lamp and thus define an effective angle of opening at least towards one side, in many cases it is desirable to utilize as much as possible of the radiated light. If the extent of the aperture is based on the central point of the discharge vessel in cross section with respect to the longitudinal direction and this is considered to be the angle of opening, the angle of opening of the light radiation, based on the same central point, of the shield will preferably be greater than that of the aperture. In this case, the shielding face can moreover screen completely light radiated from the aperture, since the light radiation in the lamp also takes place from parts of the inner sheath which are closer to the aperture, with the result that the effective light radiation angle of the aperture is greater than the angle of opening when viewed radially.

In addition, the shield can also contain further shielding elements in the region of the angle of opening in addition to the shielding face(s), in particular flat shielding parts which extend substantially radially in cross section and further divide the angle of opening. The shield can thus also be slightly improved in the direction of the light radiation. Examples will be explained further below.

It may be important for the shield to be coupled to one or more outer electrodes in a manner which is not excessively capacitive. It is in this case preferred for an assumed radial thickness d_{D} between the metallic shield and the outer electrode, i.e. approximately the thickness of the mentioned insulation layer within the metal shield, and a dielectric constant ε_{D} of this layer and a thickness d_{B} of the dielectric barrier between the electrode and the discharge medium at a corresponding dielectric constant ε_{B} to overall fulfill the following relationship:
d_{D}/ε_{D}≧F×d_{B}/ε_{B},
where the factor F is at least 1.5, preferably at least 2 and particularly preferably at least 2.5. Reference is made to EP 0 981 831 for further details in which it is also explained, inter alia, that the corresponding sum of the individual quotients of thickness and dielectric constant must be used in this relationship in the case of multilayer composites.

One simple and preferred possibility consists in at least one, preferably two end-side bases being provided on the lamp which are dimensioned to be radially slightly larger than the discharge vessel itself. If, in this case, the shield is fitted so as to bear against the base and is preferably mounted and held also in this form, the radial difference between the base and the discharge vessel gives the desired distance.

In this case, it may be quite expedient and preferred to allow the shield to come into contact with parts of the discharge vessel. Firstly, the shield can thus also act as a cooling body and act so as to provide temperature homogenization along the longitudinal extent of the lamp. In addition, a conductive layer which may be provided on the discharge vessel can thus be connected to the shield in a self-conducting manner, for example an indium/tin oxide layer, as is mentioned in the above-cited U.S. Pat. No. 6,304,028 B1. Such a conductive layer may be transparent, as is the case with indium tin oxide. In this case, it can be extended over the aperture, and a certain shielding effect is therefore also provided in this region. Such a conductive, transparent layer for shielding purposes in particular in the region of the aperture is of course also preferred in the context of the present invention irrespective of contact being made with the shield by means of direct touching contact.

A further preferred refinement of the base relates to flattened sections on its cross-sectional shape (perpendicular to the longitudinal extent of the discharge vessel) which are provided so as to also match the shield, for example a correspondingly shaped metal sheet. In this case, when mounting the shield on the bases, the alignment of the flattened sections provides a correct orientation, i.e. in particular an alignment of an aperture of the lamp with the angle of opening defined by the shield. In this case, the base can naturally also contain further latching devices which match the shield. However, a latching or clamping action may also be provided by the sleeve shape alone, i.e. by the interlocking connection of the shield itself.

The abovementioned shielding face, or the two shielding faces preferably provided, at the sides of the angle of opening can also fulfill other tasks than improving the shielding effect. In particular, they can also be used for mounting and holding purposes.

That is to say, the shield may be in the form of a sleeve, at least one outer electrode being fitted to the discharge vessel by means of an interlocking connection with the sleeve surrounding the electrode, said sleeve partially surrounding the circumference of the discharge vessel perpendicular to the longitudinal extent but in the process leaving an aperture free for light radiation purposes.

This is also of importance for a corresponding production method in which at least one electrode is fitted to a discharge vessel which is elongate in the form of a tube by means of an interlocking connection with the sleeve surrounding the electrode such that the electrode lies along the longitudinal extent of the discharge vessel, the sleeve leaving an aperture free for light radiation purposes.

The basic idea in this case consists in using a sleeve, which is integral with the shield, for the purpose of mounting the at least one electrode or preferably the two or more outer electrodes. The sleeve is in this case a device which has sufficient intrinsic dimensional stability for holding the electrodes by means of an interlocking connection. The sleeve can therefore be used, so to speak, as a clip or clamping device. This makes it possible for an aperture to be left free in order for the discharge lamp to radiate light, with the result that the sleeve does not need to be transparent or particularly thin. The sleeve also does not need to be adhesively bonded. Furthermore, it allows for stabilization and/or protection of the discharge vessel against external effects and can therefore also contribute to a reduction in the wall thicknesses of the discharge vessel which is desired for weight reasons and for preventing voltages which are too high. In particular, the electrodes can be mounted on the discharge vessel by simply being clipped onto or inserted into the sleeve such that production of the discharge lamp is markedly simplified and accelerated at this point.

Preferred features are the fact that only the mentioned interlocking connection holds the electrode, i.e. said electrode is not also adhesively bonded to the discharge vessel or fixed in another way, and also the fact that the sleeve is prestressed for this purpose, i.e. still maintains a certain contact pressure even in the mounted state.

In addition, it is also preferred for the sleeve itself to be held on the discharge vessel only by means of an interlocking connection or else a force-fitting connection as a result of its intrinsic stability, i.e. to bear against said discharge vessel freely. It should therefore likewise not additionally be adhesively bonded.

Primarily as regards the stabilization and protective function of the sleeve already mentioned, it is preferred, but not absolutely necessary in the context of the invention, for the sleeve to extend substantially along the entire discharge vessel. In an individual case, one or more sleeves may also be used which make up only part of the longitudinal extent of the discharge vessel.

In addition, the above explanation relating to the interlocking connection and the intrinsic dimensional stability of the sleeve should not be understood in such a way that they need necessarily be integral. Within the context of a particular refinement of the invention, in contrast provision is made for an at least two-part sleeve to be used. In this case, there may also be a functional differentiation, for example in the form of the outer shield and an electrical insulation lying therein between at least the electrode and the shield. In such cases, the insulation itself need not necessarily be dimensionally stable although it should be understood to be part of the sleeve.

A further possibility for a two-part or multi-part sleeve comprises two parts which have been split along the longitudinal extent of the discharge vessel and are adjacent and fixedly connected to one another in the mounted state, said parts producing an interlocking or force-fitting connection with respect to the discharge vessel in the connected state. Such parts can therefore also be placed on the discharge vessel without an interlocking and force-fitting connection and then connected to one another for the purpose of producing the interlocking or force-fitting connection. Possible connections are, in particular, screw connections or clip connections between the two parts, preferably also undetachable clip connections. This embodiment is particularly suitable for sleeves which are not made from a substantially elastic material.

In a further refinement, the outer electrodes are in the form of rods and are used as plug connection elements at one end. In this case, rod-shaped means that the electrodes have a certain intrinsic dimensional stability, and can thus be used as the plug connection element, i.e. are not foil electrodes. In particular, in this case the length and width of the electrodes transverse to the longitudinal extent should be comparable in terms of order of magnitude, for example should not differ from one another by more than a factor of 5.

In this case, the electrodes should be designed such that they can be connected to a complementary plug connection element in a form which can preferably be detached mechanically, i.e. can be isolated again without any fundamental damage. In this case, a plug connection is understood to mean a force-fitting connection, which takes place whilst maintaining the essential shape of the plug connection elements, of largely dimensionally stable elements. The plug connection is thus intended to be delimited by, for example, crimping connections, in the case of which contact is made with film-like electrodes with a substantial change to the shape of said electrodes and without using dimensional stability.

The use of the electrodes themselves as plug connection elements provides a simple design and markedly simplifies the contact-making method.

In particular, the electrodes may be simple round rods and, in this case, either have a tube end as the so-called female element of the plug connection or end as a round rod as the so-called male element. The tube end, which is designed to accommodate a round rod, can therefore be present as the female plug connection element both on the electrode side and on the cable or ballast side. Corresponding designs are naturally also possible with cross sections other than the round cross section, but the round cross section is preferred.

Moreover, the invention also relates to those discharge lamps in which the at least two opposing plug connection elements for the described electrode ends are included which are therefore, for example, already provided with a cable or packaged together with it. Preferred in this case is not only a plug connection which can be detached without any damage being caused but also a plug connection which can be produced by means of a purely translatory movement. Such plug connections are simple in design terms and allow for a particularly simple contact-making method.

Favorable geometric designs for the plug connection elements on the electrodes or the complementary plug connection elements are configured such that one element at least partially surrounds the complementary element. For example, with the connection described between a rod end and a tube end, the rod end is completely surrounded by the tube end.

If, however, a widened flat end of a rod is inserted into a slot in a complementary element, the flat end is now only surrounded on two sides, i.e. only partially, by the complementary element. This means that one element bears on at least two sides of the other element “laterally” in relation to the longitudinal direction.

The electrode ends to be used as plug connection elements preferably protrude beyond the discharge lamp and can thus be reached particularly easily for the purpose of connecting them to the complementary plug connection elements. A further refinement of the invention provides for a modular arrangement, in a row, of individual discharge vessels which can be operated jointly almost as an integral discharge lamp. In the case of the already mentioned plug connections at the end of rod-shaped electrodes, the electrodes of the individual modules can be plugged together, and in the process the sleeves of individual modules could likewise be connected to one another or designed merely to adjoin one another, but it is also possible for a continuous sleeve to be used for a plurality of modules. Even without the mentioned plug connection, this design may be advantageous, for example, if the discharge vessels are arranged next to one another in a row in modular fashion in the manner described and are held by modular or continuous sleeves and in the process continuous, outer electrodes are held by the sleeve(s) in the manner according to the invention.

The discharge lamp is intended to be connected to an electronic ballast during operation, and this electronic ballast provides the pulsed power supply already mentioned. In this case, the electrical connection between the lamp and the ballast is preferably likewise shielded. This can take place by shielding of a cable, or else owing to a direct spatial vicinity between the discharge lamp and a shielding housing of the ballast, the two being electrically conductively connected to one another and therefore concomitantly covering the electrical connection.

In particular, the shield may also have a mounting function, i.e. be fixedly connected to the ballast housing and hold the discharge lamp.

One refinement of the invention relates to an illumination system having the dielectric barrier discharge lamp, in which a plug connection element is fixedly connected to a housing of the ballast, said plug connection element being designed such that the lamp can be connected to the ballast with the end having the contacts as a complementary plug connection element by being plugged together with the plug connection element of the housing.

In addition, this aspect relates to a method for connecting the discharge lamp to the electronic ballast, in which the discharge lamp with an end having contacts to an electrical connection of the lamp, as the plug connection element, is inserted into a plug connection element, which is designed to be complementary thereto and is fixedly connected to the housing of the ballast.

The basic idea consists in a dielectric barrier discharge lamp being designed to have a discharge vessel, which is elongate in the form of a tube, to a certain extent as the plug connection element itself. For this purpose, the discharge lamp has contacts fitted at one end for the electrical connection and is connected with this end to a correspondingly designed, complementary plug connection element which is fixedly connected to the ballast, i.e. to the housing of said ballast. In this case, it is naturally possible for the ballast-side plug connection element to be connected to a printed circuit board of the ballast via a cable, but a direct mechanical connection between the lamp and the ballast should be created by the plug connection.

It is preferable in this case for the ballast-side plug connection element to not only be fixedly connected to the housing but to be integrated in the housing. In other words, the plug connection element should not be fixed. A flexible cable between the ballast housing and the lamp in the form of a flexible mechanical connection therebetween is therefore dispensed with. It is preferable for the plug connection element to be integrated flat in the ballast housing, i.e. to be in the form of a recess in an otherwise, for example, parallelepipedal housing, into which recess the tubular lamp itself can be inserted with one end. For illustrative purposes, reference is made to the exemplary embodiment.

The ballast-side plug connection element is preferably a plug socket, i.e. a female element in relation to the tube shape of the lamp.

Preferred applications of the discharge lamp according to the invention and of the illumination system according to the invention are not only in office automation but also in UV radiators. Such UV radiators can be used for various technical processes. Of particular interest in the context of this invention is the illumination of catalyst surfaces for photocatalysis of reactions. A preferred example of an application is one in air purification, in particular in vehicles, for example motor vehicles. In this case, air pollutants can be converted by a photocatalytic process and thus eliminated, and the vehicle interior can thus be supplied with air having a much better quality than that in the outside world.

### BRIEF DESCRIPTION OF THE DRAWINGS

The invention will be explained in more detail below with reference to the exemplary embodiments, it being possible for the individual features also to be essential to the invention in other combinations.

FIG. 1 shows a schematic, perspective view of an illumination system according to the invention.

FIG. 2 shows the illumination system from FIG. 1 in the case of a discharge lamp which has been removed from the ballast.

FIG. 3 shows a schematic plan view of the illumination system shown in FIG. 1.

FIG. 4a shows a schematic, perspective view of one end of the discharge lamp shown in FIGS. 1-3 in accordance with an alternative embodiment.

FIG. 4b shows a variant of FIG. 4a.

FIGS. 5-9 each show schematic front views of discharge lamps in accordance with alternative embodiments.

FIG. 10 shows a perspective illustration of one variant of a shielding plate of the discharge lamp shown in FIGS. 1-3.

FIG. 11 shows a perspective illustration of a further variant of a shielding plate of the discharge lamp shown in FIGS. 1-3.

### BEST MODE FOR CARRYING OUT THE INVENTION

Firstly, reference is made to U.S. Pat. No. 6,304,028 B1 which has already been mentioned above for the purpose of illustrating the design of a typical dielectric barrier discharge lamp having a tubular discharge vessel. Explanations which have already been given in this document are not repeated below. Instead, the description of the exemplary embodiments concentrates on the differences from this prior art.

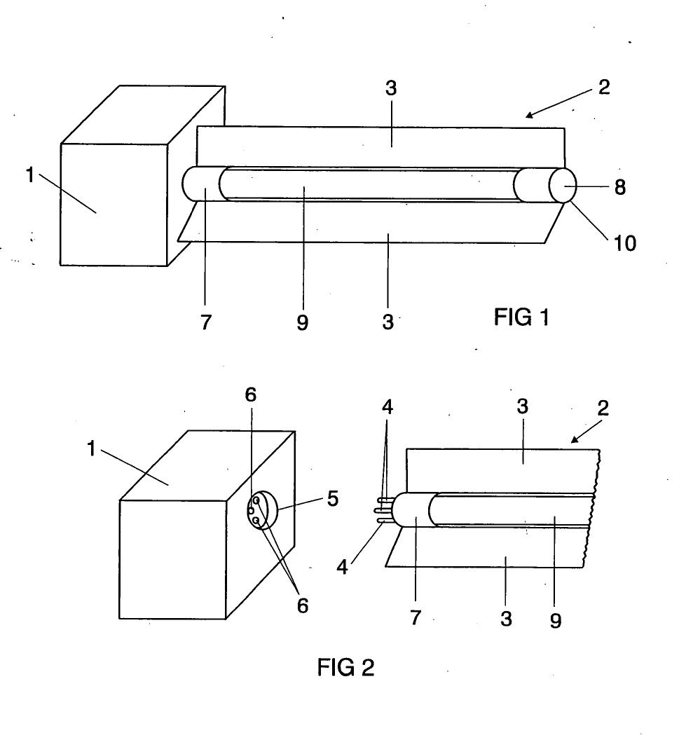

FIG. 1 of the present application shows an illumination system according to the invention having an electronic ballast 1 which is illustrated here as a simple parallelepiped. The figure shows only the housing of the ballast 1 which contains the circuit components, which are moreover known per se, of a ballast for operating a dielectric barrier discharge lamp. Of concern here is, in particular, a class E converter.

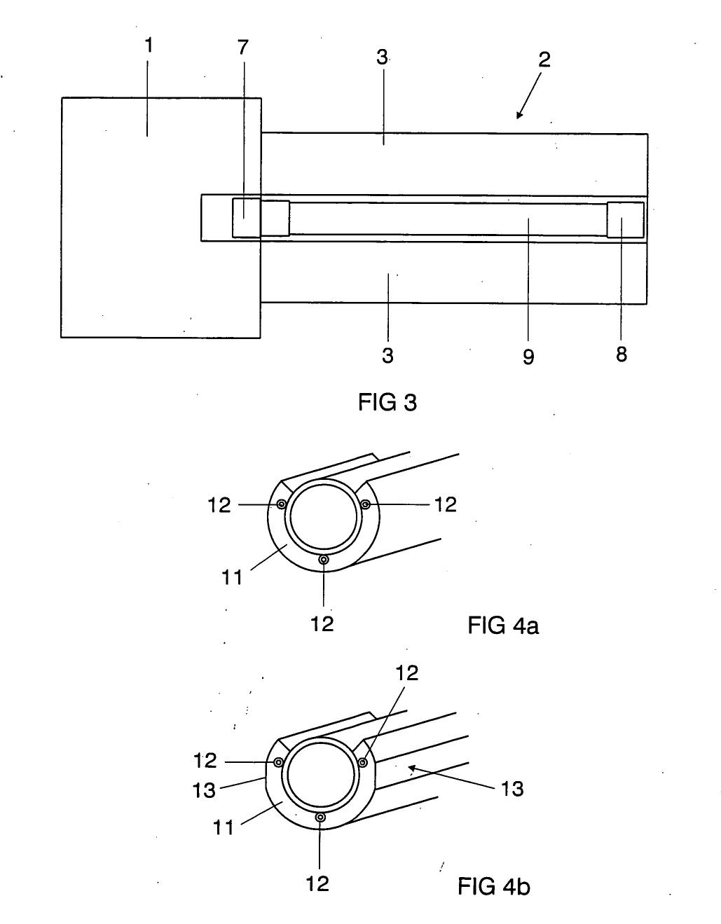

The figure shows the fact that a substantially linear dielectric barrier discharge lamp 2 having two laterally protruding shielding faces 3 is inserted into the rear region of that side of the ballast 1 which is on the right in FIG. 1. FIG. 2 shows, using a detail of the ballast 1 and the lamp 2 shown in FIG. 1, a situation in which the lamp 2 has been withdrawn from the ballast 1. FIG. 3 shows a plan view of the situation in FIG. 1.

It can be seen in FIG. 2 that a base 7 of the tubular lamp 2 protrudes to the left beyond the shielding faces 3, and this cylindrical, protruding base 7 has three further-reaching, axially extending electrode ends 4. In addition, FIG. 2 indicates that the ballast 1 has, in its right-hand side face of the otherwise parallelepipedal housing shape, a plug socket receptacle 5 suitable for this purpose having female plug connection elements 6 provided therein for the mentioned axial electrode ends 4 of the discharge lamp 2.

The axial electrode ends 4 are the ends, on the left-hand side in FIGS. 1-3, of round rod-shaped electrodes of the lamp 2 which will be explained in more detail with reference to FIGS. 4-9. As shown in FIG. 2, these electrode ends are inserted into the described plug socket 5 with the plug connection elements 6 together with the base 7, which protrudes beyond the shielding faces 3, of the discharge lamp 2. As shown in FIGS. 1 and 3, the lamp 2 is as a result not only electrically connected to the ballast 1 but is also mounted fixedly on it. The ballast 1 therefore acts as a lampholder. A flexible cable between the lamp 2 and the ballast 1 can therefore be dispensed with.

That part of the lamp 2 which reaches beyond the shielding faces 3 is a plastic base 7 which holds, together with a second base 8 which can be seen in FIGS. 1 and 3, a tubular glass discharge vessel 9 in a shielding plate 10 which has the shielding faces 3 and is described in more detail below. In FIGS. 2 and 3, the shielding plate 10 with the shielding faces 3 is electrically conductively connected to the metallic housing of the ballast 1. This can take place, for example, by a small pin (not illustrated in FIGS. 1 and 2) which bears against the outer circumference of the base 7 and is inserted with this base 7 into the plug socket 5. The shielding plate 10 is insulated from the electrodes with the ends 4 via an insulating layer which is not illustrated here but is illustrated in FIG. 4. This insulating layer is a plastic layer. This plastic insulation is not provided in that part of the discharge vessel 9 which is visible in FIGS. 1-3 between the shielding faces 3, namely the aperture for light radiation purposes. The shielding plate 10 forms a sleeve with the bases 7 and 8.

In FIG. 4a, the shielding plate 10 with the shielding faces 3 are omitted in order to provide a simple illustration. FIG. 4a shows one variant of the mentioned plastic insulation in the form of a base 11 running along the length of the lamp and otherwise electrode ends 12 which firstly do not reach beyond the base 11 and which secondly have a tubular shape. Of concern here are female plug connection elements at the electrode ends in contrast to the male plug connection elements in FIG. 2. Correspondingly, a complementary ballast (not illustrated) has male plug connection elements in a plug socket comparable to the plug socket 5 in FIG. 2. The electrodes are inserted into appropriate recesses in the base 11 and are held on the discharge vessel by said base 11 in an interlocking manner. The base 11 runs along the length of the lamp and merges with the base (8 in FIGS. 1 and 3) at the opposite lamp end. It is held under prestress with respect to the discharge vessel 9 by the shielding plate 10 and is held on said discharge vessel without further measures. The discharge vessel 9 is therefore a simple gas-filled tube having inner fluorescent and reflective layers.

Since in this case the insulating layer between the electrodes and the shielding plate 10 is at the same time in the form of a base corresponding to the base 7 in FIG. 2, the base therefore does not surround the entire circumference of the discharge vessel end.

In both cases, the embodiment in FIGS. 1-3 and that in FIG. 4a, the shielding plate 10 bears in a force-fitting and interlocking manner about the base and the insulation, and an assembly connection is therefore ensured.

FIG. 4b shows one variant of FIG. 4a in which additional flattened sections 13 are provided there in the lateral regions of the base 11. These flattened sections 13 are provided in complementary fashion on a shielding plate 10, which is in this case not illustrated in the drawings, corresponding to FIGS. 1-3, with the result that the aperture can be aligned correctly with the shielding faces 3.

The base 7 shown in FIG. 2 may also be designed such that it correspondingly adjusts the distance from the shielding plate 10 exclusively at the ends of the discharge vessel 9, and such that the insulation is introduced into the axial intermediate region only loosely or is omitted completely in the case of inner electrodes, for example.

The plug connection illustrated in FIGS. 1-3 between the discharge lamp 2 and the ballast 1 is, of course, not obligatory in the invention. Electrode ends in the form of plug connection elements can also be expedient without this feature, for example if a corresponding female plug connection head of a connection cable, which matches the electrode ends and optionally also, similarly to the socket 5, matches the base 7 or the discharge vessel 9, is provided instead of the plug socket 5 of the ballast 1.

FIGS. 5-9 show a few variants of the discharge lamps shown in FIGS. 1-4b. In this case, only two electrodes 4 are provided in FIG. 5 instead of three electrodes (or electrode ends) 4 as in FIG. 2. Both variants are possible. Three electrodes are occasionally selected in order to achieve better luminous efficiency. These differences are not of particular significance for the present invention. In addition, the angle of opening between the shielding faces 3, i.e. the blade-like ends of the sleeve 10, is in this case selected to be slightly smaller. This angle of opening, however, is dimensioned such that it does not noticeably impede the actual emergence of light from the aperture in the upper region of the section illustrated in FIG. 5. However, these shielding faces 3 serve the purpose of improving the electromagnetic shielding in the lateral direction owing to stray fields emerging from the aperture. FIG. 5 illustrates the aperture by a fluorescent layer 14 being illustrated there which is interrupted in the region of the aperture.

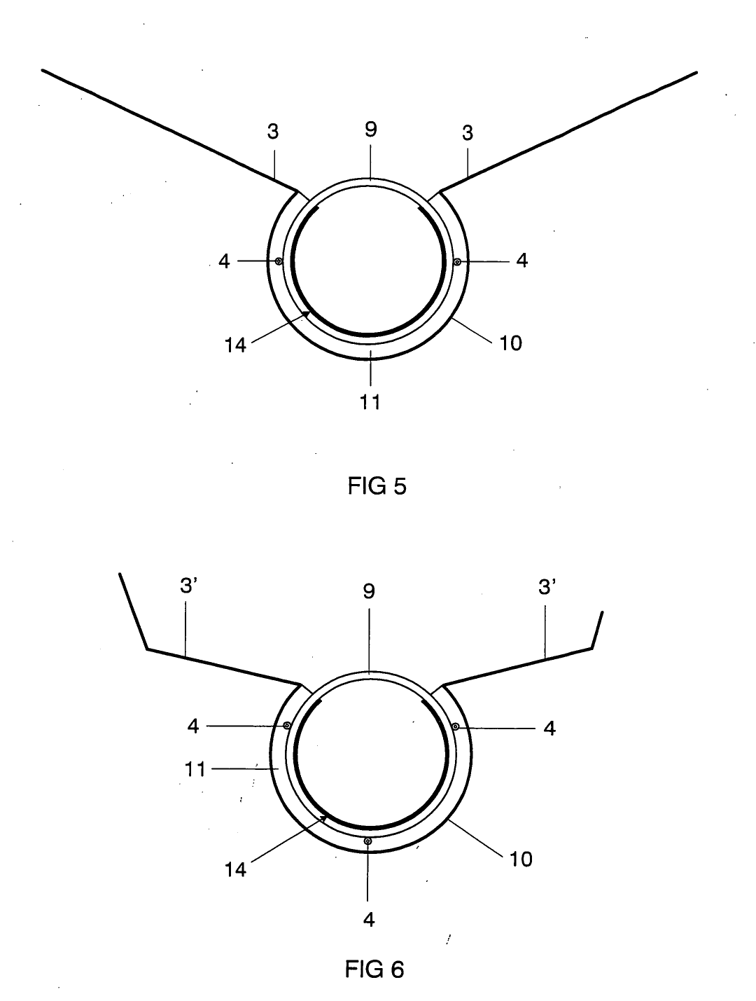

In contrast to FIG. 5, FIG. 6 again shows three electrodes 4, but the essential difference consists in the fact that the shielding faces 3′ in FIG. 6 are in this case supplemented by inwardly bent parts and thus delimit an angle of opening which is slightly narrower still. Based on the circle center point of the discharge vessel, this angle of opening is still markedly larger than the angle of opening of the aperture. However, since the edge regions of the fluorescent layer 14 also radiate light, the outermost regions of the light radiation are already screened. The shielding effect, however, is correspondingly improved.

The bent shape of the shielding faces 3′ can in this case take physical conditions in the environment into consideration, for example if the illumination system (in the sense of FIG. 1) is intended to be used in an environment with predetermined physical conditions, or if such a design appears to be advantageous for assembly purposes. FIG. 1 has already illustrated the fact that the shielding plate 10 not only serves the purpose of holding the electrodes on the discharge vessel 9 but also stabilizes the assembly of the entire discharge lamp 2 on the ballast 1. If necessary, the shielding faces 3 may also be mounted specially, for example clamped, plugged or screwed onto the ballast 1. Moreover, they may also have an assembly function with respect to components other than the ballast housing.

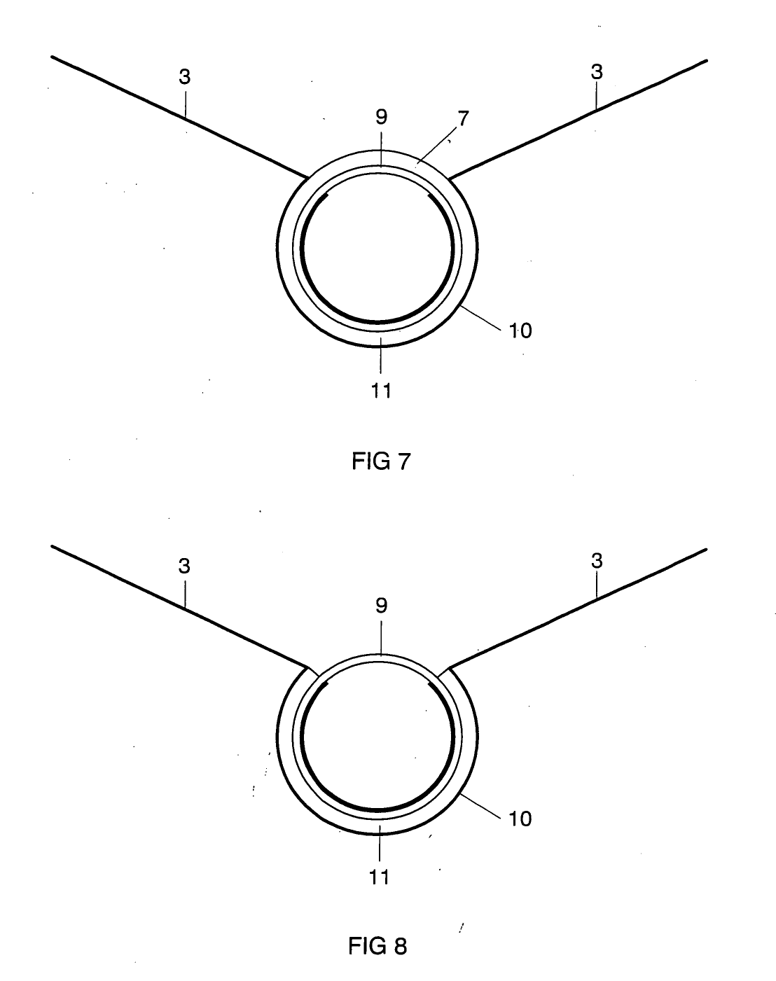

FIG. 7 shows a further variant of FIG. 5 having an angle of opening, which is again narrowed, of the shielding faces 3, but in this case with straight shielding faces 3. In this case, the base 7 as shown in FIG. 2 runs around the entire circumference of the discharge vessel 9 and does not leave the aperture free, as in FIG. 4. Since the base 7, however, is only fitted to the outermost edge, this does not disturb, or hardly disturbs, light radiation.

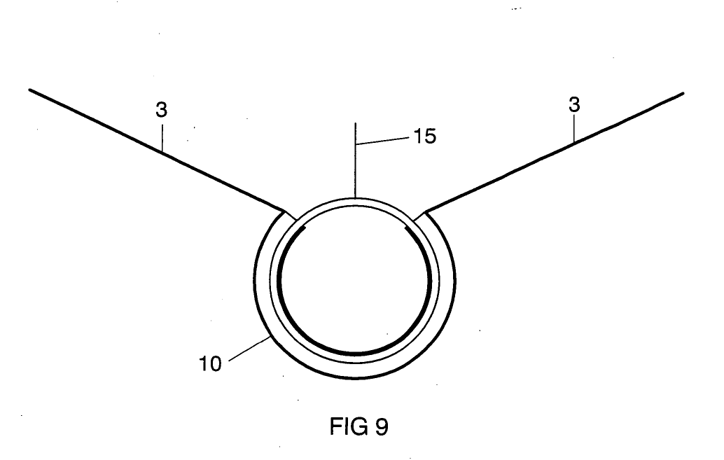

FIG. 8 differs from FIG. 7 precisely by this lastmentioned feature. Here too, the aperture is left free. The base is therefore a base 11 corresponding to FIG. 4.

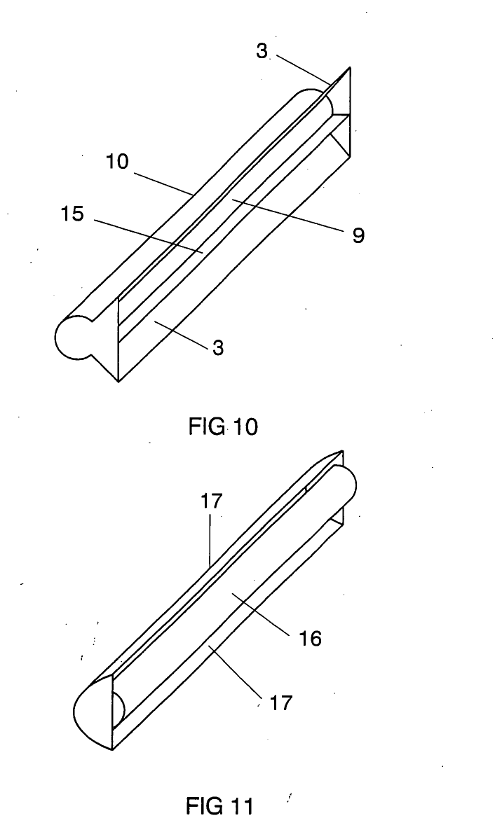

FIG. 9 differs from FIG. 8 by an additional shielding part 15 in the angle of opening both of the shielding faces 3 and the aperture. This is radial in the cross section illustrated and otherwise flat and can be seen better in the perspective view in FIG. 10. It reduces the light radiation through the aperture slightly, but improves the electromagnetic shielding in the light radiation direction as well. Such a part 15 may be a cost-effective alternative or else an additional measure to a transparent, conductive coating of the aperture, as is illustrated in the above-cited EP specification. For reasons of clarity, the details of the plug connection are omitted in FIG. 10.

FIG. 11 shows an illustration similar to that in FIG. 10 of a variant of the design of the shielding plate 10. In this case, the shielding plate 10 with the shielding faces, when viewed in section, in principle comprises two concentric semicircles 16 and 17 having substantially different diameters about the circle center point of the section through the discharge vessel 9. The semicircles 16, 17 face one another with their openings. In contrast to the previous variants, in this case the smaller of the semicircles 16 also has a markedly greater distance from the discharge vessel 9, which is not illustrated here. As a result, even the smaller semicircle 16 acts as a reflector, reflects the light radiated by the aperture into it (i.e. towards the right in FIG. 11) into the larger semicircle 17 which in turn reflects the light out of the sleeve. This variant provides markedly poorer luminous efficiency than the previous examples but shows considerably improved EMC shielding.

1. A discharge lamp comprising
a discharge vessel which is elongate in the form of a tube
a conductive metallic shield which partially surrounds the discharge vessel and in the process leaves an angle of opening free for light radiation purposes,
wherein at least one shielding face, limiting the angle of opening, of the shield being remote from the discharge vessel at its outermost end by a distance which is at least as great as half the average diameter of the discharge vessel transverse to the longitudinal extent.

2. The discharge lamp as claimed in claim 1, in which the shield forms a sleeve which surrounds the discharge vessel and engages around the discharge vessel over more than half its circumference.

3. The discharge lamp as claimed in claim 2, in which the shield surrounds the discharge vessel over part of its circumference at a smaller distance than half the average diameter of the discharge vessel, transverse to the longitudinal extent, and, starting from this region of the shield, at least one flat shielding region protrudes which forms the shielding face remote with its outermost end.

4. The discharge lamp as claimed in claim 1, in which the light radiation angle of opening of the shield is greater than an angle of opening of a light radiation aperture of the discharge lamp itself, the two angles of opening being based on the central point of the discharge vessel in cross section with respect to the longitudinal direction.

5. The discharge lamp as claimed in claim 1, in which further shielding parts are provided within the light radiation angle of opening of the shield.

6. The discharge lamp as claimed in claim 5, in which the shielding parts provided within the angle of opening are flat and are oriented substantially radially with respect to the discharge vessel.

7. The discharge lamp as claimed in claim 3, in which the following relationship applies overall to a thickness d_{D} of the insulation between the shield and the electrode, a dielectric constant ε_{D} thereof, a thickness d_{B} of a dielectric barrier between the electrode and a discharge medium and a dielectric constant ε_{B} thereof:
d_{D}/ε_{D}≧F×d_{B}/ε_{B},
where the factor F is greater than 1.5.

8. The discharge lamp as claimed in claim 7, in which the shield bears circumferentially against at least one end-side base of the lamp.

9. The discharge lamp as claimed in claim 8, in which the base and the shield have flattened sections in cross section with respect to the longitudinal extent of the lamp, said flattened sections providing the correct orientation of the lamp in the rotational sense about the longitudinal extent of the lamp when the shield is mounted.

10. The discharge lamp as claimed in claim 1 having at least one electrode which is fitted to the outside of the discharge vessel along the longitudinal extent of the discharge vessel, the electrode being fitted to the discharge vessel by means of an interlocking connection with the shield surrounding the electrode.

11. The discharge lamp as claimed in claim 1 having at least two rod-shaped electrodes which are fitted to the outside of the discharge vessel, the electrodes being in the form of a plug connection element at one end.

12. An illumination system having the discharge lamp as claimed in claim 1 and an electronic ballast for the purpose of operating the lamp to which the discharge lamp is electrically connected, the electrical connection between the ballast and the discharge lamp being shielded.

13. The illumination system as claimed in claim 12, in which the shield of the discharge lamp is directly, electrically conductively and mechanically fixedly connected to the housing of the ballast and holds the discharge lamp in relation to the housing.

14. The illumination system as claimed in claim 12, in which the discharge lamp has contacts, which are fitted at one end of the discharge vessel, for electrically connecting the lamp, a plug connection element being fixedly connected to a housing of the ballast, said plug connection element being designed such that the lamp can be connected to the ballast with the end having the contacts as the complementary plug connection element by being plugged together with the plug connection element of the housing.

15. The use of the discharge lamp as claimed in claim 1 as a UV radiator for the purpose of illuminating a catalyst.

16. The use as claimed in claim 15, in which the catalyst is used for air purification purposes in a vehicle.

17. The discharge lamp as claimed in claim 2 in which the light radiation angle of opening of the shield is greater than an angle of opening of a light radiation aperture of the discharge lamp itself, the two angles of opening being based on the central point of the discharge vessel in cross section with respect to the longitudinal direction.

18. The discharge lamp as claimed in claim 2, in which further shielding parts are provided within the light radiation angle of opening of the shield.

19. The discharge lamp as claimed in claim 2 having at least one electrode which is fitted to the outside of the discharge vessel along the longitudinal extent of the discharge vessel, the electrode being fitted to the discharge vessel by means of an interlocking connection with the shield surrounding the electrode.

20. The illumination system as claimed in claim 13, in which the discharge lamp has contacts, which are fitted at one end of the discharge vessel, for electrically connecting the lamp, a plug connection element being fixedly connected to a housing of the ballast, said plug connection element being designed such that the lamp can be connected to the ballast with the end having the contacts as the complementary plug connection element by being plugged together with the plug connection element of the housing.
